(19) United States
(12) Patent Application Publication
(10) Pub. No.: US 2011/0242410 A1
(43) Pub. Date: Oct. 6, 2011

(54) METHOD AND DATA CARRIER FOR FURNISHING VIDEO AND/OR AUDIO INFORMATION IN DIFFERENT FORMATS

(76) Inventor: Michael Gutowski, Baden-Baden (DE)

(21) Appl. No.: 13/133,090

(22) PCT Filed: Jul. 21, 2010
(86) PCT No.: PCT/DE2010/000852

§ 371 Date: Jun. 6, 2011

(30) Foreign Application Priority Data
Aug. 24, 2009 (DE) 10 2009 038 399.9
Oct. 20, 2009 (DE) 10 2009 050 082.0

(51) Int. Cl. H04N 7/04

(52) U.S. Cl. 348/469; 348/E07.04

(57) ABSTRACT

The invention relates to a method for providing image and/or sound information in digital form, in particular of films, for transmission to a preferably mobile device by means of computers, comprising the following method steps: —providing the digital image and/or sound information in at least two formats on a data carrier; —providing software for recognizing a device connected to the computer and the format required there and for transmitting the image and/or sound information onto the device; —detecting and recognizing the device connected to the computer together with the format; —selecting the suitable format; —transmitting the image and/or sound information in the selected format onto the device. The invention further relates to a corresponding data carrier.

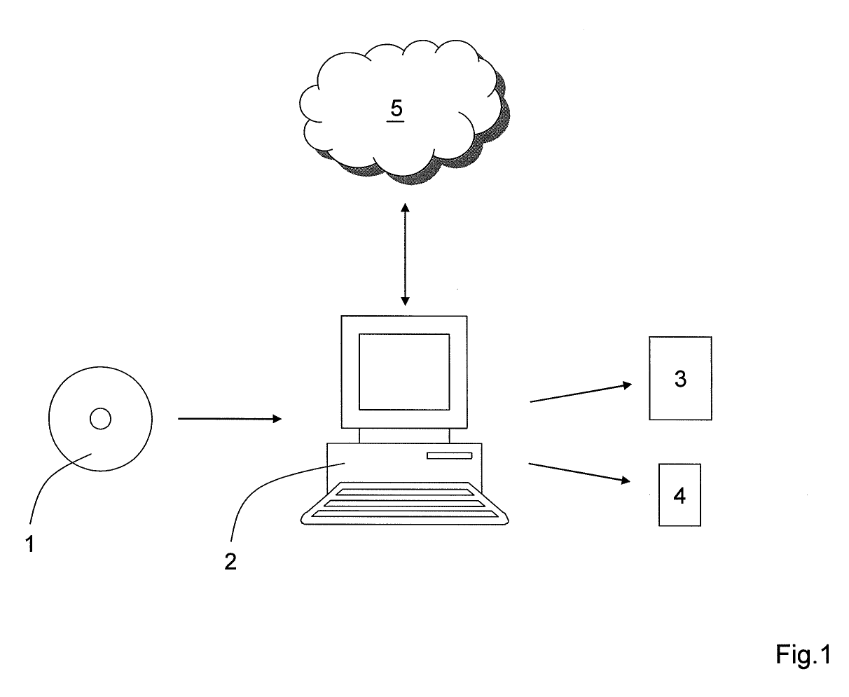

The invention concerns a method for furnishing image and/or audio information in digital form, especially films, for transmission to a preferably mobile device by means of a computer. The invention also concerns a data carrier to furnish corresponding video and/or audio information, namely especially films, for transmission to a preferably mobile device by means of a computer for use of the method according to the invention.

The video and/or audio information at issue here can be video and/or audio information of any type. The conventional film can be mentioned as an example, which nowadays is regularly made available on DVD or most recently on Blue Ray. Corresponding films can be purchased and viewed with a television via appropriate playback devices. The data format is defined according to the resolution achieved in modern televisions in order to achieve the best possible video and audio quality during playback.

Nowadays there are increasingly more mobile devices on which films can be stored and played back or viewed. Modern cell phones and also MP3 players with corresponding functions are equipped with sufficiently large display. The cell phones available on the market operate with different operating systems. Not infrequently, their video equipment requires a wide variety of film formats. The same applies for the video-capable MP3 player. Films in the required format are already being offered via the Internet, for example, via iTunes for the iPod or iPhone (registered trademarks of Apple). These formats cannot be used on other handheld devices, or can but only with reduced quality.

Conversion programs are also already offered via the Internet with which the DVD/Blue Ray format can be converted for storage and playback on a mobile device. Automatic optimization to a specific device or specific format does not occur. In addition, the handling of such programs requires not insignificant experience with the use of corresponding software. This is time-consuming and not practicable for the unskilled user.

It should also be noted here that the copying rights to the film are not acquired with the purchase of a DVD/Blue Ray. The copying of corresponding films, even with converted format, regularly violates copyright and sometimes is even a criminal act. In any event it is prohibited to circumvent copying protection. By offering the conversion programs just discussed via the Internet circumvention of copyright and even the commission of a crime is therefore required. Not rarely, such crimes are committed without knowledge of the specific criminal and civil consequences.

The present invention is therefore based on the fundamental idea and task of making video and/or audio information available in digital form, especially films, which are suitable in simple fashion for legal transmission to a preferably mobile device by means of computer. Consequently, it is a question of offering the purchasers/owners of mobile devices, like video-capable cell phones, organizers, MP3 players, etc. the possibility of legally acquiring a data carrier that contains the film of interest in the appropriate format in order to then transmit it to the corresponding mobile device. A corresponding data carrier with the digital information appropriate for transmission can also be offered in a set, in addition to the data carrier appropriate for playback on a DVD player or Blue Ray player.

The underlying task here, namely implementation of a method for furnishing video and/or audio information in digital form for transmission to a preferably mobile device by means of a computer is solved by the following method steps according to Claim 1:

Initially the digital video and/or audio information is furnished in at least one additional format and on a data carrier. The format can be a format for an ordinary cell phone with video function or a correspondingly equipped MP3 player. In any case the digital video and/or audio information is made available in the corresponding format on the data carrier so that the purchaser of the data carrier can use corresponding mobile devices to store the data and ultimately play back the film.

A special software and interface are also furnished. The software serves for recognition of a device connected to the computer and the format required there and serves for transmission of the video and/or audio information to the device. The computer on which the furnished software runs is therefore necessary. By means of this software a device connected to the computer, for example, cell phone or MP3 player, is recognized. This implies recognition of the corresponding format. It is also conceivable that the user selects the corresponding format via a button. The software also serves for the transmission of the video and/or audio information from the data carrier to the corresponding device either via the computer or directly to the device, in which case the program running on the computer searches for the appropriate format on the data carrier.

Specifically, the device connected to the computer, for example, via a USB cable, is recorded and the format recognized. As an alternative the format is selected by the user via a menu. Selection of the matching format on the data carrier occurs according to the recognized device or selected device or the format can be selected by the user. The video and/or audio information is then transferred to the device connected to the computer in matching format so that the data are then available on the mobile device for playback.

The software can then be designed so that after transmission of data no additional transmission to a second or third device is possible. It is also conceivable that transmission of the data can be carried out to a stipulated number of devices. The program can also contain a function according to which additional data transmission is only possible if previously transmitted data on a registered device are erased again so that the transmission function (transmission of data to an additional device) is released again.

In particularly advantageous fashion the corresponding format with which the video and/or audio information is made available on the data carrier has resolution optimized for the mobile device. Moreover, a data rate/file size optimized for the device as well as a frame rate optimized for the corresponding device and/or a codec optimized for the corresponding device can also be implemented. It is essential that a fairly significant data reduction be conducted, for example to about 1 GB per film, starting from the maximum video and/or audio information made available for high resolution color television via DVD or Blue Ray. The resolution and data rate/file size, etc. are optimized in each case with allowance for the corresponding device in every respect, namely with consideration of the operating system, the screen size, etc. of the device. It is essential for the method according to the invention that the video and/or audio information be made available not only in digital form with reduced data volume relative to conventional DVD or Blue Ray, but rather in a format optimized for the corresponding mobile device. The user therefore has the possibility of searching for the format intended for his device and loading the data from the data carrier onto his mobile device by means of the computer. Optimal video/audio quality is then implemented on the mobile device, namely with consideration of the individual hardware and software.

In principle, a hard drive, for example, a mobile hard drive can be used as a data carrier. It is of particular advantage to use a CD, DVD or Blue Ray or memory stick as a data carrier. Ultimately the digital video and/or audio information can be made available on any data carriers provided the capacity of the data carrier is sufficient to furnish the same video and/or audio information in different formats, for example, in three to five formats.

It was already mentioned that the method according to the invention also includes furnishing of special software that serves for recognition of a device connected to the computer and the format required there. The software also serves for transmission of the video and/or audio information to the device. It is then particularly advantageous if the software/application is furnished on the same data carrier as the video and/or audio information so that it is merely necessary to load the data carrier containing the video and/or audio information and the software onto the computer.

In principle, it is conceivable that the software is loaded manually after insertion of the data carrier. Such a method step is then required, in particular, if no autostart function is available on the computer. If a corresponding autostart function can be used, it is also advantageous that the software is automatically loaded with insertion of the data carrier, in which case it is a further advantage, regardless of loading method, if a user-friendly menu is provided and optionally automatically opened with the loading of the software (manually or automatically).

In the context of the method according to the invention simple handling is a particular advantage for the unskilled user in the EDP sector if the user is placed in a position via a simple menu to load the video and/or audio information acquired in different formats onto his mobile device and then obtain a best possible resolution via the optimized format.

In the context of using the user-friendly menu it is a further advantage if this is equipped for the individual selection of parameters, especially in the device and/or the format and/or the transmission operation with the simplest user instructions. It is thus conceivable that the user specifies a connected device or selects it from the menu or that the device is automatically recognized. The format matching it is also selected manually or automatically and optionally displayed. Only confirmation by the user is required for transmission of data to the corresponding device. Data transmission (after recognition of the format) can also occur automatically.

It is also conceivable that a device is recognized for which no optimized format of the video and/or audio information is available on the data carrier. To this extent a format can be offered via the software that matches best. In any event, the user has the possibility of activating the transmission of the video and/or audio information on the menu by the simplest user instructions without thorough EDP knowledge, whereupon it is displayed on the screen of his computer if the transmission function is running. The end of transmission is displayed after complete transmission of the data so that the user can disconnect his mobile device from the computer.

Especially for reasons of copyright claims it can be essential that, after insertion of the data carrier or with the finishing of the menu, in any case before data transmission, registration via the Internet be offered or required. To secure copyright claims a release code is transmitted with registration, which is required for the activation of the data transmission. It is also conceivable that the release code is already furnished on purchasing the data carrier or automatically based on a recognition of the data carrier via the Internet without requiring a separate registration.

It has already been mentioned that the device connected to the computer, for example, a commercial cell phone with video function, is recognized by the computer. Recognition can occur automatically based on correspondingly designed software. The same applies for the parameters, especially from the matching format of the corresponding device. The selection on the data carrier can also occur automatically so that the user does not have do to anything further than connect his mobile device to the computer and start the software required for data transmission, if it is not started automatically anyway on insertion of the data carrier.

Specifically, the video and/or audio information (after recognition and selection by means of the software) can be transmitted to an appropriate mobile device, for example, a mobile telephone, a smartphone, a PTA, a handheld computer, a handheld console, etc. It is not absolutely necessary that the mobile device also be simultaneously suited for playback of a film. Instead, pure data transmission to a corresponding device is initially involved, which can but need not include a display appropriate for playback of the film.

With reference to an appropriate data carrier for furnishing video and/or audio information in digital form, the task mentioned in the introduction is solved by the features of the dependent Claim 18. The video and/or audio information is made available via the data carrier in digital form, especially films, for transmissions to the preferably mobile device, in which case the data carrier serves for the use of the method according to the invention. According to the method of the invention the data carrier includes the same digital video and/or audio information in at least two selectable (common) formats.

It is also advantageous if the software required for handling is contained on the data carrier in addition to the digital video and/or audio information so that the user-friendly menu required for handling can be started with the loading of a single data carrier without requiring additional method steps.

There are now different possibilities of configuring and modifying the instructions of the present invention advantageously. For this purpose, on the one hand, the claims subordinate to Claim 1 and, on the other hand, the following explanation of a preferred practical example of the invention by means of the drawing are referred to. In conjunction with the explanation of the preferred practical example of the invention by means of the drawing, generally preferred embodiments and modifications of the instructions are explained. In the drawing the single

FIGURE shows in a schematic view the method according to the invention, using a data carrier according to the invention.

The single FIGURE schematically depicts the basic function of the method according to the invention, according to which video and/or audio information is furnished in digital form with different formats on a data carrier 1, for example a CD or DVD. The video and/or audio information, for example, could be a film.

The data carrier 1 includes the digital data of the film in at least one additional format, as is required on mobile devices, for example, different cell phones, for storage and optical playback. Advantageously the data carrier 1 includes at least two different formats.

The data carrier 1 is read in a computer 2. Special software is situated on the data carrier 1 which is manually or automatically loaded by computer 2. The user-friendly menu is preferably automatically opened on the screen of the computer 2, which instructs the user in the uncomplicated selection of the corresponding format and data transmission.

A mobile device 3 or two mobile devices 3, 4 are connected to the computer 2, depending on the underlying license. The required format is preferably recognized automatically via the software and the file of video and/or audio information is selected that is transmitted to the corresponding device 3, 4 to produce optimized quality. The selected, matching format of the video and/or audio information is transmitted to the mobile device 3, 4 based on the simplest user instructions.

The single FIGURE also shows that the computer 2 can communicate via the Internet 5 with a web service which, for example, queries or conducts registration and/or reads or assigns a release code. Any Internet services can be integrated in the method, especially security functions.

With respect to additional advantageous embodiments of the device according to the invention the general part of the description and the appended claims are referred to in order to avoid repetitions.

Finally, it is explicitly pointed out that the practical example of a method according to the invention and the data carrier according to the invention described above merely serves to explain the claimed instructions but does not restrict them to the practical example.

### LIST OF REFERENCE NUMBERS

1 Data carrier
2 Computer
3 Mobile device
4 Mobile device
5 Internet, web service

1.-19. (canceled)

20. A method for furnishing video and/or audio information in digital form, especially films, for transmission to a preferably mobile device by means of a computer, said method comprising:
furnishing the digital video and/or audio information in at least two formats on a data carrier;
furnishing software for the selection or recognition of a device connected to the computer and the format required there, as well as for the transmission of the video and/or audio information to the device;
recording and recognizing the device connected to the computer in addition to format;
selecting the matching format; and
transmitting of the video and/or audio information in the selected format to the device,
wherein the software/application is furnished on the same data carrier as the video and/or audio information.

21. The method according to claim 20, characterized by the fact that the corresponding format has resolution optimized for the corresponding device.

22. The method according to claim 20, wherein the corresponding format has data rate/file size optimized for the corresponding device.

23. The method according to claim 20, wherein the corresponding format has a frame rate optimized for the corresponding device and/or a codec optimized for the corresponding device.

24. The method according to claim 20, wherein a hard disk is used as a data carrier.

25. The method according to claim 20, wherein a CD, DVD, Blue Ray, memory stick or the like is used as data carrier.

26. The method according to claim 20, wherein the software is manually loaded after insertion of the data carrier.

27. The method according to claim 20, wherein the software is automatically loaded with insertion of the data carrier.

28. The method according to claim 20, wherein a user-friendly menu is furnished and optionally automatically opened with the loading of the software.

29. The method according to claim 28, wherein the menu serves for the individual selection of parameters, especially of the device and/or format and/or transmission operation.

30. The method according to claim 20, wherein after the insertion of the data carrier or with the furnishing of the menu and before the data transmission a registration is offered or required via the Internet.

31. The method according to claim 20, wherein a release code is required for the activation of the data transmission.

32. The method according to claim 31, wherein the release code is furnished on purchasing the data carrier or via the Internet.

33. The method according to claim 20, wherein the device connected to the computer is recognized automatically.

34. The method according to claim 20, wherein the parameters, especially the matching format, are/is automatically selected.

35. The method according to claim 20, wherein the video and/or audio information—after recognition and selection—is transmitted to a mobile telephone, smartphone, PDA, handheld computer, handheld console, etc.

36. A data carrier for furnishing video and/or audio information in digital form, especially film, for the transmission to a preferably mobile device by means of a computer, said data carrier configured to include the digital video and/or audio information in at least two formats.

37. The data carrier according to claim 36, wherein software required for handling is present on the data carrier in addition to the digital video and/or audio information.
